(19) United States
(12) Patent Application Publication
(10) Pub. No.: US 2022/0398519 A1
(43) Pub. Date: Dec. 15, 2022

(54) SYSTEMS AND METHODS FOR ASSET-CENTERED EXPENSE FORCASTING

(71) Applicant: INTUIT INC., Mountain View, CA (US)

(72) Inventors: Yair HORESH, Tel Aviv (IL); Daniel Ben DAVID, Tel Aviv (IL)

(73) Assignee: Intuit Inc., Mountain View, CA (US)

(21) Appl. No.: 17/347,499

(22) Filed: Jun. 14, 2021

(51) Int. Cl. G06Q 10/06; G06K 9/62; G06Q 40/00

(52) U.S. Cl. CPC G06Q 10/06315; G06K 9/6222; G06Q 40/12

(57) ABSTRACT

Systems and methods for asset-centered expense forecasting.

### BACKGROUND OF THE DISCLOSURE

For accounting purposes, the movement of finances (e.g., for small business or other similar entities) is typically split into the following categories: equity, expenses, income, liabilities, and assets. Splitting the movement of finances into these categories allows accounting teams to manage expenditures, track incoming funds, monitor diminishing values, etc. Small businesses and other entities often face the dilemma of deciding whether to continue investing in an asset or to cut losses on said asset. For example, a small business may have purchased a work vehicle that continues to incur garage and repair costs. It can be difficult for that small business to perform the relevant analysis to make an informed decision on whether to persist with the asset or not.

### BRIEF DESCRIPTION OF THE FIGURES

FIG. 1 is a block diagram of an example system for asset-centered expense forecasting according to some embodiments of the present disclosure.

FIG. 2 is a flow diagram showing an example processing to create a linked asset-expense model according to some embodiments of the present disclosure.

FIG. 3 is a flow diagram showing an example processing to generate an expense forecast according to some embodiments of the present disclosure.

FIG. 4 is a flow diagram showing an example processing to generate a profit ratio estimate according to some embodiments of the present disclosure.

FIG. 5 is an example server that can be used within the system of FIG. 1 according to an embodiment of the present disclosure.

FIG. 6 is an example computing device that can be used within the system of FIG. 1 according to an embodiment of the present disclosure.

### DETAILED DESCRIPTION OF SEVERAL EMBODIMENTS

Embodiments of the present disclosure relate to systems and methods for probabilistic, asset-centered expense forecasting and profit estimation. In one or more embodiments, the systems and methods detect connection between assets and future expenses using statistical and probabilistic methodologies and use those connections for forecasting. The disclosed system can extract various data from small business financial reports and perform various analyses to associate big expenses (i.e., assets) with continuing expenses. For example, the system may access a database of financial transactions associated with financial tools or other planning platforms, such as Credit Karma™, Mint™, QuickBooks®, etc. Using word embeddings and vectorization and clustering techniques, the system analyzes the financial transaction data to cluster together consecutive expenses and provide estimates of future expenses based on similar cases. In other words, the disclosed embodiments can aggregate data from a population of users to provide expense forecasts to individual users.

A major technical advantage of the disclosed embodiments is the increased accuracy and the increased temporal duration to which the increased accuracy applies. In general, existing forecasting models look for repeated patterns with an organization's transactions and make assumptions (e.g., based on statistics) on how far these patterns will continue. While this type of forecasting may be fairly accurate over short timeframes (e.g., days to a few weeks), accuracy over longer timeframes (e.g., months to years) is lacking. In contrast, the disclosed embodiments utilize statistical analyses of a large population of the organizations' transaction data to determine patterns and apply these patterns to individual entities. This results in a greater accuracy and for longer periods of time.

The disclosed embodiments can also provide indications as to how these expenses can affect profit. Returning to the work vehicle example described above, the disclosed embodiments can indicate to the small business whether the vehicle expenses are likely to increase, decrease, or remain steady in future. Such information can provide great value to the small business in terms of making more educated decisions on whether to persist and maintain various assets. An example of a forecasting indication generated by the disclosed system is a prediction that, if a certain asset is purchased (e.g., a truck in a specific industry, such as an ice cream truck), there is a certain likelihood that maintenance and repairs will cost $5,000 over the next year. While there are other types of expense forecasting models, these models do not utilize probabilistic calculations.

As described herein, assets refer to a user or organization's resources or larger items that are purchased, owned, or rented. Examples include land, buildings, vehicles, equipment, etc. Expenses refer to operation costs that a user or organization pays to generate revenue, such as e.g., repairs, maintenance, replacement parts, storage costs, etc. In some embodiments, expenses can include cost-of-goods sold information and transactions demarcated as “other expenses.” It should be appreciated that while the disclosed examples refer to small businesses, the disclosed embodiments are not so limited and can be used with any user or organization and or business model.

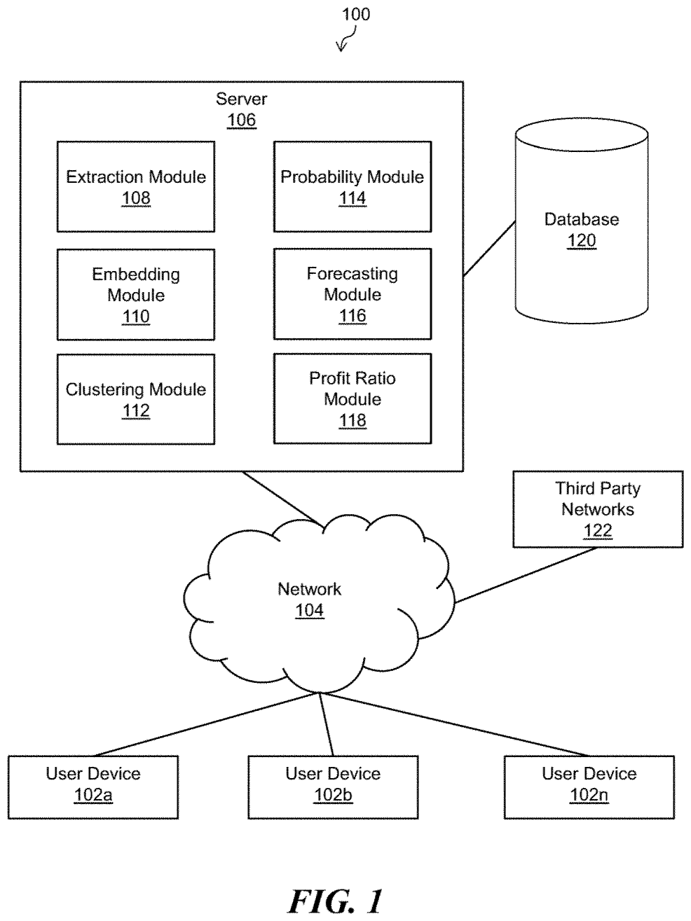

FIG. 1 is a block diagram of an example system 100 for asset-centered expense and profit forecasting according to some embodiments of the present disclosure. The system 100 can include a plurality of user devices 102a-n (generally referred to herein as a “user device 102” or collectively referred to herein as “user devices 102”) and a server 106, which are communicably coupled via a network 104. In some embodiments, the system 100 can include any number of user devices. For example, for an organization that manages accounting software and an associated database, there may be an extensive userbase with thousands or even millions of users that connect to the system 100 via their user devices 102. Components of the system 100 can also communicate with one or more third party networks 122 (e.g., financial networks) via the network 104. The server 106 can be configured to receive financial transaction information from the third party networks 122 associated with the various users of user devices 102. For example, a user can, via its user device 102, connect his/her financial instruments (e.g., checking accounts, savings accounts, credit cards, investment accounts, etc.) to a planning tool (e.g., Credit Karma™, Mint™, QuickBooks®, etc.) so that transaction information is compiled on behalf of the user. Once the connection is defined, the server 106 can be authorized to obtain transaction information associated with the connected financial instruments from the third party networks 122. In some embodiments, the transaction information is received in real time and or in periodic batches. In addition, the server 106 is communicably coupled to a database 120, which stores all transaction information associated with the userbase of the user devices 102. The transaction information stored in the database 120 can be information obtained from the third party networks 122 or it can be manually entered via the user devices 102. Transaction information includes various transactional metadata, such as a name/title/description, a date of the transaction, an amount, and recipient/sender information. In addition, in one or more embodiments, the database 120 records embedded transaction categorizations, such as whether transactions are considered equity, expenses, income, liabilities, or assets. A typical mechanism for categorizing transactions for accounting purposes entails labeling transactions as assets, equity, expenses, income, or liabilities. In one or more embodiments, the database 120 also stored profit and loss financial reports for its userbase.

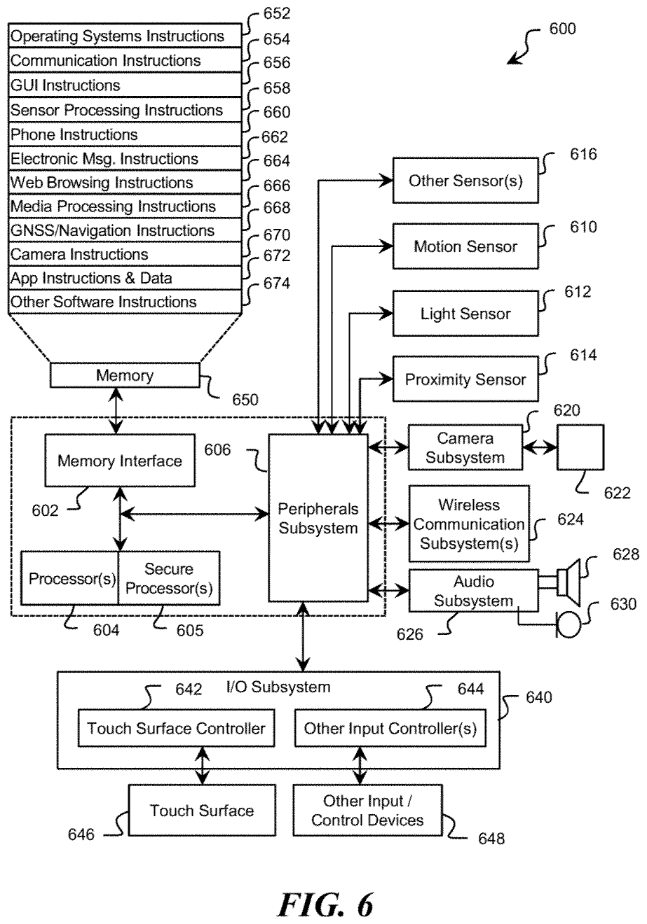

A user device 102 can include one or more computing devices capable of receiving user input, transmitting and/or receiving data via the network 104, and or communicating with the server 106. In some embodiments, a user device 102 can be a conventional computer system, such as a desktop or laptop computer. Alternatively, a user device 102 can be a device having computer functionality, such as a personal digital assistant (PDA), a mobile telephone, a smartphone, or other suitable device. In some embodiments, a user device 102 can be the same as or similar to the computing device 600 described below with respect to FIG. 6. In some embodiments, the system 100 can include any number of user devices 102.

The network 104 can include one or more wide areas networks (WANs), metropolitan area networks (MANs), local area networks (LANs), personal area networks (PANs), or any combination of these networks. The network 104 can include a combination of one or more types of networks, such as Internet, intranet, Ethernet, twisted-pair, coaxial cable, fiber optic, cellular, satellite, IEEE 801.11, terrestrial, and/or other types of wired or wireless networks. The network 104 can also use standard communication technologies and/or protocols.

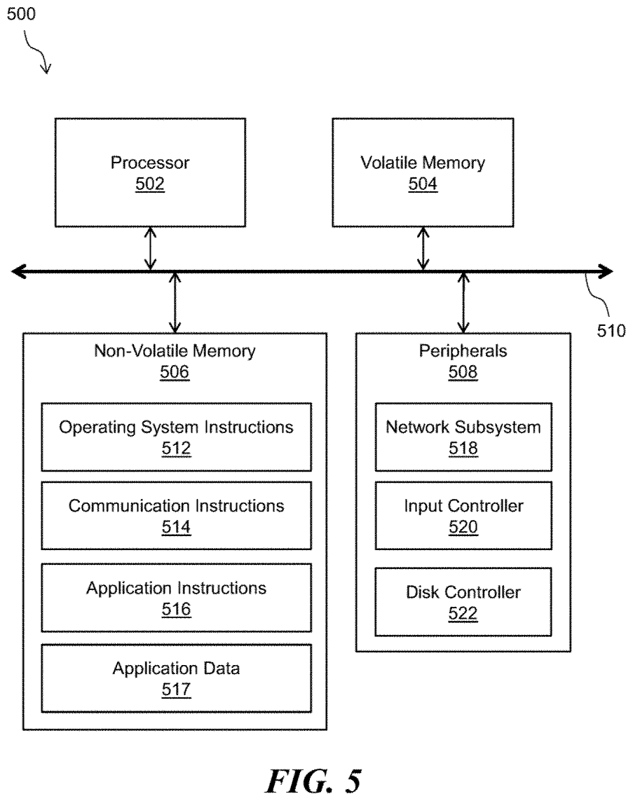

The server 106 may include any combination of one or more of web servers, mainframe computers, general-purpose computers, personal computers, or other types of computing devices. The server 106 may represent distributed servers that are remotely located and communicate over a communications network, or over a dedicated network such as a local area network (LAN). The server 106 may also include one or more back-end servers for carrying out one or more aspects of the present disclosure. In some embodiments, the server 106 may be the same as or similar to server 500 described below in the context of FIG. 5.

As shown in FIG. 1, the server 106 includes an extraction module 108, an embedding module 110, a clustering module 112, a probability module 114, a forecasting module 116, and a profit ratio module 118. The server 106 can access the database 120 to obtain transactional metadata for use by the various modules. The extraction module 108 is configured to access the database 120 and extract asset and expense information for analysis.

The embedding module 110 is configured to embed text to vector form within a continuous vector space (i.e., to vectorize the text). In some embodiments, the embedding module 110 uses a word2vec model to embed words and short phrases, such as titles, descriptions, and other transactional metadata to vector form. The word2vec model can be a standard word2vec model or a modified model pretrained on a small business domain or other financial domain for use with a specific platform such as Credit Karma™, Mint™, QuickBooks®, etc. For example, a transaction description and other metadata can be embedded to a three hundred-dimensional vector in the vector space. It is important to note that the dimensionality of the vector can be less than or greater than three hundred (e.g., fifty, two hundred, five hundred, etc.). The embedding module 110 can utilize various techniques for generating the word embeddings, such as a continuous bag-of-words approach (CBOW) or a skip-gram approach. Other embedding frameworks can also be utilized, such as GloVe (Global Vector) or FastText. Parameters used to create vector representations may be variable and may be adjusted or tuned based on learning. In some embodiments, the embedding module 110 includes an encoder and/or a neural network architecture to perform the embedding processes.

The clustering module 112 is configured to generate clusters of vectors within a vector space, such as the vectors embedded to the vector space by the embedding module 110. In some embodiments, the clustering module 112 uses a DBSCAN (density-based spatial cluster of applications with noise) clustering algorithm. In other embodiments, the clustering module 112 can utilize various clustering techniques, such as mean-shift clustering, hierarchical clustering, k-means, affinity propagation, spectral clustering, OPTICS, Gaussian mixture modeling, or Birch clustering. In some embodiments, the clustering module 112 can utilize a BERT (bidirectional encoder representation from transformers) model. The BERT model can be used as a language processing model and include various transformer encoder blocks to understand contextual relations between words; the model operates on and processes word or text vectors (e.g., text that has been embedded to a vector space). The BERT model can thus be used by clustering module 112 to perform clustering of the word vectors in order to increase the similarity and homogeneity levels within each generated cluster.

The probability module 114 is configured to analyze a dataset of transactional metadata (which can be in the form of vectors) to calculate various probabilistic relationships. Given a dataset of assets and expenses, the probability module 114 calculates conditional probabilities associated with such assets and expenses. For example, the probability module 114 can calculate the probability that, given the occurrence of two or more expenses (e.g., purchases of air conditioning filters), a related asset (e.g., an air conditioner) was purchased beforehand. Probability module 114 can determine such probability values for any kind of asset purchases tagged in database 120; the resulting probabilities are stored in database 120 and used to link expenses and assets and generate expense forecasts.

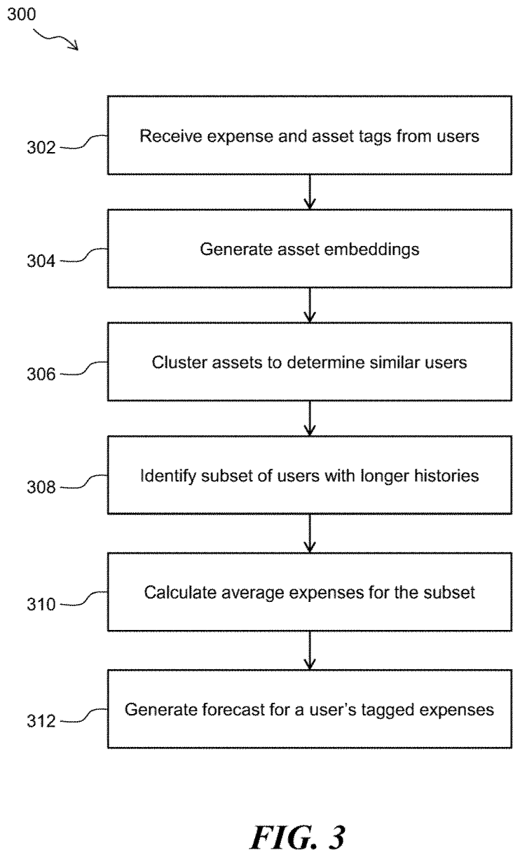

The forecasting module 116 is configured to generate forecasts for a user. For example, a user can indicate that an asset was purchased or that an asset is desired to be purchased; the forecasting module 116 generates a forecast for the asset purchase that includes estimates of future expenses associated with the asset. The estimates can be calculated based on the probability values calculated by the probability module 114. Additional details on the generation of expense forecasts are described with respect to FIG. 3.

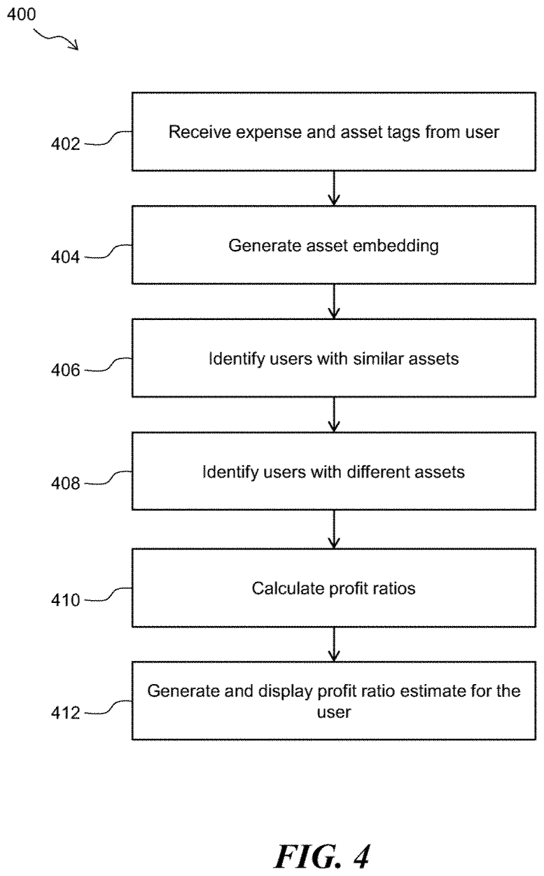

The profit ratio module 118 is configured to generate profit ratio estimates for a user. For example, a user can indicate that an asset was purchased or that an asset is desired to be purchased; the profit ratio module 118 can then generate a profit ratio estimate comparing profit patterns for other similar users before and after the purchase of similar assets. In another example, the profit ratio module 118 generates a profit ratio estimate comparing predicted profit patterns for users that purchased a similar asset to profit patterns for users that did not purchase the asset. Additional details on the generation of profit ratio estimates are discussed with respect to FIGS. 3 and 4.

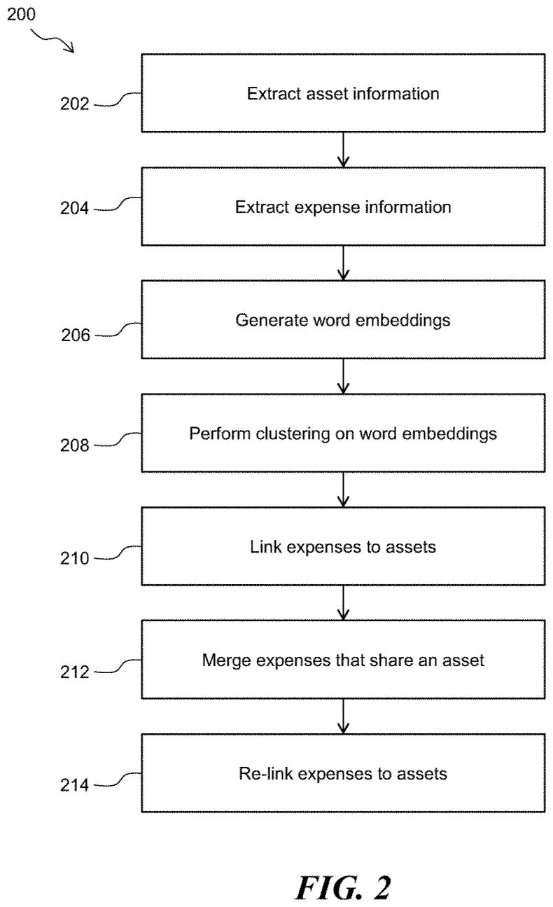

FIG. 2 is a flow diagram showing an example process 200 to create a linked asset-expense model according to some embodiments of the present disclosure. The process 200 can be performed by the server 106 and its various modules. At block 202, the extraction module 108 extracts asset information from the database 120. As mentioned above, the database 120 stores transaction categorizations (e.g., for accounting purposes). For example, the database 120 can include information associated with transactions that indicates whether it has been labelled as an asset, equity, expense, income, or a liability. Therefore, extraction module 108 accesses database 120 and extracts transactional metadata for each transaction labelled as an asset. At block 204, the extraction module 108 extracts expense information from the database 120. For example, the extraction module 108 accesses the database 120 and extracts transactional metadata for each transaction labelled as an expense. In some embodiments, the extraction module 108 may only extract expense information for users and or organizations that have purchased at least one asset. For both blocks 202 and 204, the extracted information can include various transactional metadata, such as e.g., a name/title/description, date of the transaction, an amount, and a recipient/sender of the information. In some embodiments, the information extracted for each transaction (whether it is an asset or an expense) can be in the form of JavaScript Object Notation (JSON) or other similar formats.

At block 206, the embedding module 110 generates word embeddings based on the transactional metadata received for both the expenses and the assets. In other words, the embedding module 110 converts the expense transactions and asset transactions (e.g., the description) into vectors: these are referred to herein as expense vectors and asset vectors, respectively. Both the expense vectors and asset vectors are defined in the same vector space. At block 208, the clustering module 112 performs clustering on both the expense vectors and the asset vectors, generating clusters of similar terms. For example, an expense with a description “garage” and an expense with a description “auto repair shop” could be merged together in the same cluster because of their similarity to each other. In some embodiments, DBSCAN clustering techniques are used, which measure the density of distances between the various vectors and uses these densities to define clusters. The transactions that are defined to reside within the same cluster can be demarcated as such, such as via a tag or token added to the transaction and stored in the database 120.

At block 210, the probability module 114 links expenses to assets. In some embodiments, such a linking procedure can include for each expense calculating a conditional probability. The conditional probability can be defined as the following: given k instances of the expense or similar expenses (e.g., expenses within the same cluster as defined above by the clustering module 112) occurring within a year of a certain date and zero instances of the expense/similar expenses occurring before said date, calculate the probability that an asset was purchased on that date. In some embodiments, rather than performing block 210 for each expense, the probability module 114 can perform block 210 on each cluster of expenses, as generated at block 208. In some embodiments, k can be two, three, four, etc. For example, given a user or organization (e.g., small business account) that had two expenses related to air conditioning, the probability module 114 can determine if an asset (e.g., such as an air conditioner) was purchased by that same user or organization prior to the two expenses. The probability module 114 can perform this analysis on all of the expenses in a cluster and determine the probability that there was an occurrence of such an expense. If the probability is above a pre-defined threshold (defined herein as a linking threshold), the associated assets and expenses can be recorded as “linked” and demarcated as such in the database 120.

At block 212, the probability module 114 merges expenses that have been linked with the same asset (i.e., expenses in which the probability value at block 210 was determined to be above the linking threshold). This processing step can combine inherently different expenses that were not originally merged together by the clustering module 112, but are still determined to be tied to the same asset. The probability module 114 then inserts tags indicating that these expenses are tied to the same assets, which are stored within the database 120. At block 214, the probability module 114 re-links expenses to assets. Re-linking expenses and assets can include re-calculating the probability values in the same or a similar manner as at block 210, except now more of the expenses have been identified as being related to the assets. The recalculated probability values are also stored in the database 120.

FIG. 3 is a flow diagram showing an example process 300, which can be performed to generate an expense forecast according to some embodiments of the present disclosure. Process 300 can be performed by the server 106 and its various modules. At block 302, the server 106 receives expense and asset tags from users that are a part of an accounting or financial platforms userbase. Because the platform is able to track (either automatically or by manual entry) financial and accounting transactions for its users, the user (e.g., via user device 102) can manually tag these transactions as expenses or assets. At block 304, the embedding module 110 generates asset embeddings for its userbase (i.e., generates asset vectors for various asset purchases). In some embodiments, generating the asset vectors includes vectorizing the asset description and cost. At block 306, the clustering module 112 clusters the asset vectors to determine similar users. By generating clusters of asset vectors, the clustering module 112 can determine that users or organizations that have purchased similar assets (i.e., assets in the same cluster) are similar entities, at least to the extent that similar forecasting models can apply to both of them. For example, a forecast of expenses for the purchase of an air conditioning asset can be similar for separate businesses, even if they are typically seen as operating in different fields.

At block 308, to generate a forecast for a particular asset purchase from a first user or organization, the forecasting module 116 identifies a subset of other users from the userbase that purchased a similar asset with longer histories than the first user. In some embodiments, a longer history can include other users that have purchased a similar asset at least one year before the first user, although other values can be used (e.g., users whose asset is above a certain age). At block 310, the forecasting module 116 calculates an average expense value for the subset of users identified at block 308. Calculating an average expense can include, for each user within the subset, identifying expenses that are linked to the asset (see block 214 of FIG. 2) that have transaction dates within one year from the purchase of the asset date and calculating their total cost in that year period. Forecasting module 116 can calculate the total cost of related expenses for each user and use that cost to obtain an average value per asset purchased. At block 312, the forecasting module 116 can generate a forecast for a user's tagged expense. After a user tags a transaction as an asset, the forecasting module 116 can provide an indication to the user at user device 102 that displays an estimated cost of expenses to be incurred over the next year for the asset. It should be appreciated that the year-long timeframe is merely an example and various timeframes less than or greater than a year could be used. In addition, it should be appreciated that the asset may not have been already purchased. For example, a user could, via user device 102, log onto the planning platform and input details describing a potential asset purchase; a forecast could then be generated for the potential asset purchase.

In some embodiments, the forecasting module 116 can utilizes additional statistical methods and indicators when generating the forecast. For example, the forecasting module 116 can determine a standard error for the expense forecast, a volatility index and a confidence level of the expense forecast. In addition, the forecasting module 116 can provide a range of expected expense costs to be incurred over the next year based on the detected volatility and standard error. For example, the larger the standard error, the larger the range of expense spending can be provided. Furthermore, the forecasting module 116 can rely on standard deviation statistics when determining the range to provide to the user. For example, the range could be the average plus or minus one or more standard deviations.

FIG. 4 is a flow diagram showing an example process 400, which can be performed to generate a profit ratio estimate according to some embodiments of the present disclosure. Process 400 can be performed by the server 106 and its various modules. At block 402, the server 106 receives expense and asset tags from users that are a part of an accounting or financial platforms userbase. Because the platform is able to track (either automatically or by manual entry) financial and accounting transactions for its users, the user (e.g., via user device 102) can manually tag these transactions as expenses or assets. The users can include a first user, whom the profit ratio estimate will be generated for. At block 404, the embedding module 110 generates asset embeddings for its userbase (i.e., generates asset vectors for various asset purchases). In some embodiments, generating the asset vectors can include vectorizing the asset description and cost. At block 406, the clustering module 112 identifies users of the platforms userbase that share similar assets to the first user. In some embodiments, identifying users that share similar assets can include clustering the asset vectors to determine similar users. By generating clusters of asset vectors, the clustering module 112 can determine that users or organizations that have purchased similar assets (i.e., assets in the same cluster) are similar entities.

At block 408, the clustering module 112 identifies users within the userbase that do not share assets to the first user (i.e., users that have not purchased a similar asset to the first user). In some embodiments, users within the userbase that do not share assets to the first user can be identified as similar to the user based on other attributes, such as industry, volume of revenue, location, etc. At block 410, the profit ratio module 118 calculates profit ratios for the users. Calculating a profit ratio can include, for each user or organization identified as having purchased a similar asset, calculating a profit for a period of time (e.g., one year, two years, etc.) prior to the purchase of the asset and calculating a profit for a similar period of time after the purchase of the asset. In some embodiments, profit can be defined as the following: profit=(income)−(cost-of-goods-sold)−(expenses)−(other expenses). In some embodiments, the profit calculations can also include depreciation rates of the asset. The after-asset profit divided by the before-asset profit (or other variation) can be considered a profit ratio. In one or more embodiments, the profit ratio module 118 calculates a profit ratio for the users identified as having similar assets. In addition, the profit ratio module 118 can calculate a similar ratio based on the same time period to determine a profit ratio for the users that did not purchase the asset. The profit ratio module 118 can combine the profit ratios for the users with similar assets to calculate an average asset-based profit ratio estimate. In addition, the profit ratio module 118 can combine the profit ratios for the users without similar assets to calculate an average control group profit ratio. At block 412, the profit ratio module 118 generates and displays the profit ratio estimate for the first user. The profit ratio module 118 can also display the comparison between the profit ratio estimate and the control group profit ratio to provide context to the first user on the financial effects of purchasing the asset. In some embodiments, if the profit ratio estimate differs from the control group profit ratio in a statistically significant way (e.g., at least one standard error or standard deviation gap), the profit ratio module 118 can indicate as much to the first user.

FIG. 5 is a diagram of an example server device 500 that can be used within system 100 of FIG. 1. The server device 500 can implement various features and processes as described herein. The server device 500 can be implemented on any electronic device that runs software applications derived from complied instructions, including without limitation personal computers, servers, smart phones, media players, electronic tablets, game consoles, email devices, etc. In some implementations, the server device 500 includes one or more processors 502, volatile memory 504, non-volatile memory 506, and one or more peripherals 508. These components can be interconnected by one or more computer buses 510.

The processor(s) 502 can use any known processor technology, including but not limited to graphics processors and multi-core processors. Suitable processors for the execution of a program of instructions can include, by way of example, both general and special purpose microprocessors, and the sole processor or one of multiple processors or cores, of any kind of computer. Bus 510 can be any known internal or external bus technology, including but not limited to ISA, EISA, PCI, PCI Express, USB, Serial ATA, or FireWire. The volatile memory 504 can include, for example, SDRAM. Each processor 502 can receive instructions and data from a read-only memory or a random access memory or both. Essential elements of a computer can include a processor for executing instructions and one or more memories for storing instructions and data.

The non-volatile memory 506 can include by way of example semiconductor memory devices, such as EPROM, EEPROM, and flash memory devices; magnetic disks such as internal hard disks and removable disks; magneto-optical disks; and CD-ROM and DVD-ROM disks. The non-volatile memory 506 can store various computer instructions including operating system instructions 512, communication instructions 514, application instructions 516, and application data 517. The operating system instructions 512 can include instructions for implementing an operating system (e.g., Mac OS®, Windows®, or Linux). The operating system can be multi-user, multiprocessing, multitasking, multithreading, real-time, and the like. The communication instructions 514 can include network communications instructions, for example, software for implementing communication protocols, such as TCP/IP, HTTP, Ethernet, telephony, etc. The application instructions 516 can include instructions for asset-centered expense forecasting according to the systems and methods disclosed herein. For example, the application instructions 516 can include instructions for the components 108-118 described above in conjunction with FIG. 1. The application data 517 can include data corresponding to the components 108-118 described above in conjunction with FIG. 1.

The peripherals 508 can be included within the server device 500 or operatively coupled to communicate with the server device 500. The peripherals 508 can include, for example, network subsystem 518, input controller 520, and disk controller 522. The network subsystem 518 can include, for example, an Ethernet of WiFi adapter. The input controller 520 can be any known input device technology, including but not limited to a keyboard (including a virtual keyboard), mouse, track ball, and touch-sensitive pad or display. The disk controller 522 can include one or more mass storage devices for storing data files; such devices include magnetic disks, such as internal hard disks and removable disks; magneto-optical disks; and optical disks.

FIG. 6 is an example computing device that can be used within the system 100 of FIG. 1, according to an embodiment of the present disclosure. In some embodiments, the device 600 can be any of the user devices 102a-n. The illustrative user device 600 can include a memory interface 602, one or more data processors, image processors, central processing units 604, and/or secure processing units 605, and a peripherals subsystem 606. The memory interface 602, one or more central processing units 604 and/or secure processing units 605, and/or peripherals subsystem 606 can be separate components or can be integrated in one or more integrated circuits. The various components in user device 600 can be coupled by one or more communication buses or signal lines.

Sensors, devices, and subsystems can be coupled to the peripherals subsystem 606 to facilitate multiple functionalities. For example, a motion sensor 610, light sensor 612, and proximity sensor 614 can be coupled to peripherals subsystem 606 to facilitate orientation, lighting, and proximity functions. Other sensors 616 can also be connected to the peripherals subsystem 606, such as a global navigation satellite system (GNSS) (e.g., GPS receiver), a temperature sensor, a biometric sensor, magnetometer, or other sensing device, to facilitate related functionalities.

A camera subsystem 620 and an optical sensor 622, e.g., a charged coupled device (CCD) or a complementary metal-oxide semiconductor (CMOS) optical sensor, can be utilized to facilitate camera functions, such as recording photographs and video clips. The camera subsystem 620 and the optical sensor 622 can be used to collect images of a user to be used during authentication of a user, e.g., by performing facial recognition analysis.

Communication functions can be facilitated through one or more wired and/or wireless communication subsystems 624, which can include radio frequency receivers and transmitters and/or optical (e.g., infrared) receivers and transmitters. For example, the Bluetooth (e.g., Bluetooth low energy (BTLE)) and/or WiFi communications described herein can be handled by the wireless communication subsystems 624. The specific design and implementation of the communication subsystems 624 can depend on the communication network(s) over which the user device 600 is intended to operate. For example, the user device 600 can include a communication subsystems 624 designed to operate over a GSM network, a GPRS network, an EDGE network, a WiFi or WiMax network, and a Bluetooth™ network. In another example, the wireless communication subsystems 624 can include hosting protocols such that the user device 600 can be configured as a base station for other wireless devices and/or to provide a WiFi service.

An audio subsystem 626 can be coupled to a speaker 628 and a microphone 630 to facilitate voice-enabled functions, such as speaker recognition, voice replication, digital recording, and telephony functions. The audio subsystem 626 can be configured to facilitate processing voice commands, voice-printing, and voice authentication, for example.

An I/O subsystem 640 can include a touch-surface controller 642 and/or other input controller(s) 644. The touch-surface controller 642 can be coupled to a touch-surface 646. The touch-surface 646 and touch-surface controller 642 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch-surface 646.

The other input controller(s) 644 can be coupled to other input/control devices 648, such as one or more buttons, rocker switches, thumb-wheel, infrared port, USB port, and/or a pointer device such as a stylus. The one or more buttons (not shown) can include an up/down button for a volume control of speaker 628 and/or a microphone 630.

In some implementations, a pressing of the button for a first duration can disengage a lock of the touch-surface 646; and a pressing of the button for a second duration that is longer than the first duration can turn power to the user device 600 on or off. Pressing the button for a third duration can activate a voice control, or voice command, module that enables the user to speak commands into microphone 630 to cause the device to execute the spoken command. The user can customize a functionality of one or more of the buttons. The touch-surface 646 can, for example, also be used to implement virtual or soft buttons and/or a keyboard.

In some implementations, the user device 600 can present recorded audio and/or video files, such as MP3, AAC, and MPEG files. In some implementations, the user device 600 can include the functionality of an MP3 player, such as an iPod™. The user device 600 can, therefore, include a 36-pin connector and/or 8-pin connector that is compatible with the iPod. Other input/output and control devices can also be used.

The memory interface 602 can be coupled to a memory 650. The memory 650 can include high-speed random access memory and/or non-volatile memory, such as one or more magnetic disk storage devices, one or more optical storage devices, and/or flash memory (e.g., NAND, NOR). The memory 650 can store an operating system 652, such as Darwin, RTXC, LINUX, UNIX, OS X, Windows, or an embedded operating system such as VxWorks.

The operating system 652 can include instructions for handling basic system services and for performing hardware dependent tasks. In some implementations, the operating system 652 can be a kernel (e.g., UNIX kernel). In some implementations, the operating system 652 can include instructions for performing voice authentication.

The memory 650 can also store communication instructions 654 to facilitate communicating with one or more additional devices, one or more computers and/or one or more servers. The memory 650 can include graphical user interface instructions 656 to facilitate graphic user interface processing; sensor processing instructions 658 to facilitate sensor-related processing and functions; phone instructions 660 to facilitate phone-related processes and functions; electronic messaging instructions 662 to facilitate electronic messaging-related process and functions; web browsing instructions 664 to facilitate web browsing-related processes and functions; media processing instructions 666 to facilitate media processing-related functions and processes; GNSS/Navigation instructions 668 to facilitate GNSS and navigation-related processes and instructions; and/or camera instructions 670 to facilitate camera-related processes and functions.

The memory 650 can store application (or “app”) instructions and data 672, such as instructions for the apps described above in the context of FIGS. 1-5. The memory 650 can also store other software instructions 674 for various other software applications in place on the user device 600.

The described features can be implemented in one or more computer programs that can be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions can include, by way of example, both general and special purpose microprocessors, and the sole processor or one of multiple processors or cores, of any kind of computer. Generally, a processor can receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as an LED or LCD monitor for displaying information to the user and a keyboard and a pointing device such as a mouse or a trackball by which the user may provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API. An API may define one or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

While various embodiments have been described above, it should be understood that they have been presented by way of example and not limitation. It will be apparent to persons skilled in the relevant art(s) that various changes in form and detail may be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings. Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

1. A method, performed by at least one processor, of asset evaluation, said method comprising:
receiving asset information for an asset from a first user;
embedding the asset information to a vector space to generate an asset vector;
clustering the asset vector and a plurality of other asset vectors associated with a plurality of other users to generate a cluster of similar users;
identifying, from the cluster of similar users, a subset of users;
calculating an average value for the subset of users;
generating a forecast for the asset, the forecast comprising the average value; and
outputting the forecast to be displayed on a device associated with the first user.

2. The method of claim 1, wherein clustering the asset vector and the plurality of other asset vectors comprises applying a density-based spatial cluster of applications with noise (DBSCAN) clustering method to the asset vector and other asset vectors.

3. The method of claim 1, wherein identifying the subset of users comprises identifying users from the cluster of similar users who's associated asset vectors are associated with an asset transaction of at least a threshold age.

4. The method of claim 3 comprising identifying users from the cluster of similar users who's associated asset vectors are associated with an asset transaction at least one year in age.

5. The method of claim 1, wherein the value is cost and calculating the average value for the subset of users comprises, for each user of the subset:
identifying one or more expense transactions associated with the respective user, wherein the one or more expense transactions have been linked to the asset via a clustering algorithm; and
calculating a total cost of the one or more expense transactions.

6. The method of claim 5, wherein the one or more expense transactions were linked to the asset if a number of users purchasing the one or more expense transactions and the asset exceeds a linking threshold.

7. The method of claim 5 comprising receiving expense tags for the one or more expense transactions from the plurality of other users.

8. The method of claim 1, wherein generating the forecast for the asset comprises:
calculating at least one of a standard error, a volatility index, or a standard deviation for the average value; and
providing a range of values for the average value based on at least one of the standard error, the volatility index, or the standard deviation.

9. The method of claim 1 comprising receiving asset tags for the respective plurality of other assets associated with the plurality of other asset vectors from the plurality of other users.

10. A system comprising:
a processor; and
a non-transitory computer-readable medium storing instructions that, when executed by the processor, causes the processor to perform a method of expense forecasting comprising:
receiving asset information for an asset from a first user;
embedding the asset information to a vector space to generate an asset vector;
clustering the asset vector and a plurality of other asset vectors associated with a plurality of other users to generate a cluster of similar users;
identifying, from the cluster of similar users, a subset of users;
calculating an average value for the subset of users;
generating a forecast for the asset, the forecast comprising the average value; and
causing the forecast to be displayed on a device associated with the first user.

11. The system of claim 10, wherein clustering the asset vector and the plurality of other asset vectors comprises applying a density-based spatial cluster of applications with noise (DBSCAN) clustering algorithm.

12. The system of claim 10, wherein identifying the subset of users comprises identifying users from the cluster of similar users who's associated asset vectors are associated with an asset transaction of at least a threshold age.

13. The system of claim 12, comprising identifying users from the cluster of similar users who's associated asset vectors are associated with an asset transaction at least one year in age.

14. The system of claim 10, wherein calculating the average value for the subset of users comprises, for each user of the subset:
identifying one or more expense transactions associated with the respective user, wherein the one or more expense transactions have been linked to the asset via a clustering algorithm; and
calculating a total cost of the one or more expense transactions.

15. The system of claim 14, wherein the one or more expense transactions were linked to the asset if a number of users purchasing the one or more expense transactions and the asset exceeds a linking threshold.

16. The system of claim 14, comprising receiving expense tags for the one or more expense transactions from the plurality of other users.

17. The system of claim 10, generating the forecast for the asset comprises:
calculating at least one of a standard error, a volatility index, or a standard deviation for the average value; and
providing a range of values for the average value based on at least one of the standard error, the volatility index, or the standard deviation.

18. The system of claim 10 comprising receiving asset tags for the respective plurality of other assets associated with the plurality of other asset from the plurality of other users.

19. A system comprising:
a processor; and
a non-transitory computer-readable medium storing instructions that, when executed by the processor, causes the processor to perform a method of expense forecasting comprising:
receiving asset information for an asset from a first user, the asset information comprising a transaction date;
embedding the asset information to a vector space to generate an asset vector;
clustering the asset vector and a plurality of other asset vectors associated with a plurality of other users to generate a cluster of similar users;
identifying, from the cluster of similar users, a first subset of similar users;
identifying, from at least one other cluster, a second subset of similar users;
calculating a profit ratio estimate for the first user; and
causing the profit ratio estimate to be displayed on a device associated with the first user.

20. The system of claim 19, wherein calculating the profit ratio estimate for the first user comprises:
calculating, for the first subset of similar users, a first profit ratio associated with a time period before the transaction date and a time period after the transaction date;
calculating, for the second subset of similar users, a second profit ratio associated with the time period before the transaction date and the time period after the transaction date; and
in response to determining a difference between the first profit ratio and the second profit ratio above a pre-defined threshold, notifying the first user.
